(19) United States
(12) Patent Application Publication
(10) Pub. No.: US 2026/0274028 A1
(43) Pub. Date: Sep. 17, 2026

(54) SLIDER SUSPENSION ASSEMBLY WITH AIR TANK MOUNTING ARRANGEMENT

(71) Applicant: SAF-Holland, Inc., Muskegon, MI (US)

(72) Inventors: Marc R. Johnson, Spring Lake, MI (US); Jeffrey M. Galla, Muskegon, MI (US)

(21) Appl. No.: 19/552,272

(22) Filed: Feb. 27, 2026

Related U.S. Application Data
(60) Provisional application No. 63/767,762, filed on Mar. 6, 2025.

(51) Int. Cl. B60G 11/107; B60G 11/04

(52) U.S. Cl. CPC B60G 11/107; B60G 11/04; B60G 2202/112; B60G 2204/15

(57) ABSTRACT

A vehicle suspension arrangement includes a suspension slider assembly that includes first and second longitudinal frame members configured to be slidably coupled to first and second vehicle frame members, and a pair of lateral frame members extending between and connected to the first longitudinal frame member, such that the frame members define an open space therebetween, at least one mounting bracket connected to both of the lateral frame members, an air tank connected to the pair of lateral frame members via the at least one mounting bracket such that the air tank is at least partially positioned within the open space, an axle member configured to support a pair of wheel assemblies, and a suspension assembly configured to support the suspension slider assembly from the axle member.

### CROSS-REFERENCE TO RELATED APPLICATIONS

This application claims benefit to U.S. Provisional Patent Application No. 63/767,762, filed Mar. 6, 2025, entitled SLIDER SUSPENSION ASSEMBLY WITH AIR TANK MOUNTING ARRANGEMENT, the entire disclosure of which is incorporated herein by reference.

### BACKGROUND OF THE INVENTION

The embodiments as shown and described herein relate to a vehicle suspension arrangement, particularly for heavy-duty vehicles, and specifically a vehicle suspension arrangement that allows sliding repositioning of a supporting suspension assembly with respect to an associated vehicle frame assembly and which includes a mounting arrangement for supporting an air tank from the slider assembly.

### SUMMARY OF THE INVENTION

An embodiment of the vehicle suspension arrangement as shown and described herein may include a suspension slider assembly including a first longitudinal frame member configured to be slidably coupled to a first vehicle frame member, a second longitudinal frame member laterally spaced from the first longitudinal frame member and configured to be slidably coupled to a second vehicle frame member, and a pair of lateral frame members extending between and connected to the first longitudinal frame member, the second longitudinal frame member, the first and second lateral frame members defining an open space therebetween, at least one mounting bracket connected to both of the lateral frame members of the pair of lateral frame members, an air tank connected to the pair of lateral frame members via the at least one mounting bracket such that the air tank is at least partially positioned within the open space between the first and second lateral frame members, an axle member configured to support a pair of wheel assemblies, and a suspension assembly configured to support the suspension slider assembly from the axle member.

These and other features, advantages, and objects of the embodiments as shown and described herein will be further understood and appreciated by those skilled in the art by reference to the following specification, claims and appended drawings.

### BRIEF DESCRIPTION OF THE DRAWINGS

FIG. 1 is a top perspective view of a slider suspension assembly;

FIG. 2 is a bottom perspective view of the slider suspension assembly;

FIG. 3 is an exploded bottom perspective view of the slider assembly;

FIG. 4 is a bottom plan view of an alternative embodiment of the slider assembly; and

FIG. 5 is a side elevational view of the alternative embodiment of the slider assembly with a longitudinal frame member removed.

### DETAILED DESCRIPTION OF THE PREFERRED EMBODIMENTS

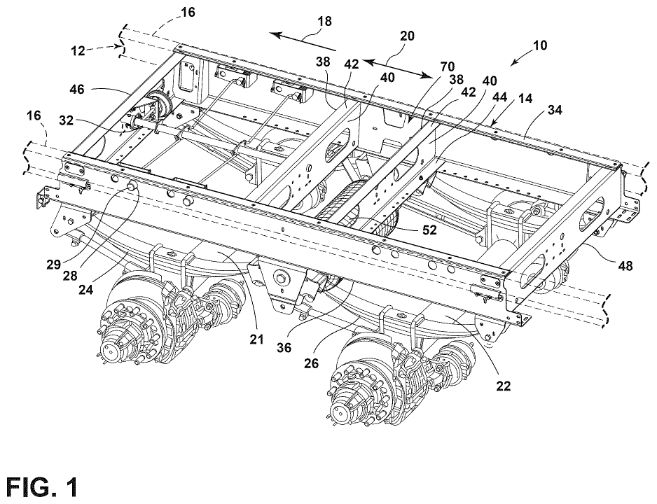

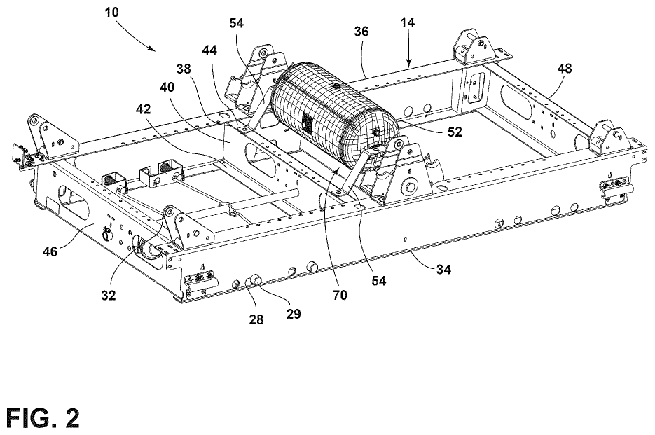

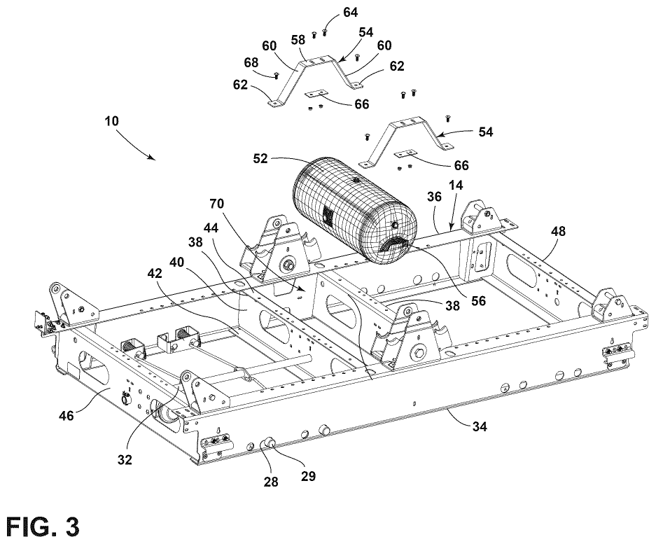

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

As best illustrated in FIG. 1, a vehicle suspension arrangement 10 slidably engages a vehicle frame assembly 12 to support an associated overall vehicle assembly, and in particular a commercial vehicle such as a semi-truck trailer, at various preselected positions along the length of the vehicle frame assembly 12. In the illustrated example, the vehicle suspension arrangement 10 includes a suspension slider assembly 14 that slidably engages a pair of longitudinally extending frame rails 16 of the vehicle frame assembly 12, where the overall vehicle assembly travels in a direction 18, and the suspension slider assembly 14 is adjustable in the directions 20 relative to the vehicle frame assembly 12. The vehicle suspension arrangement further includes a pair of axle members, including a forward and rearward axle member 21, 22 supported by associated leaf spring assemblies 24, 26, such that the axle members 20, 22 are spaced along the length of the suspension slider assembly. Although the present example includes a spring suspension assembly other suspension assembly types may also be utilized, including but not limited to mechanical and air suspension arrangements. Each axle member 21, 22 supports at least one wheel (not shown) that is positioned at the ends thereof which supports the overall vehicle from the ground surface.

Each longitudinal frame rail 16 has a Z-shaped cross-sectional configuration and a plurality of locking apertures 28 spaced along the length thereof. The locking apertures 28 are configured to receive locking pins 29 of a conventional slider position locking arrangement 32, where the locking pins 29 are engageable in and disengageable from the locking apertures 28 so as to allow repositioning of the suspension slider assembly 14 along the length of the vehicle frame assembly 12.

In the illustrated example, the suspension only slider assembly 14 includes a pair of longitudinally-extending frame members including a first longitudinal frame member 34 and a second longitudinal frame member 36 slidably engaging the frame rails 16, and a pair of central lateral frame members 38 extending between and weldably connected to the first longitudinal frame member 34 and the second longitudinal frame member 36. Each lateral frame member 38 has a C-shaped cross-sectional configuration including a vertical center or body portion 40, a top flange 42 extending orthogonally from the body portion 40, and a bottom flange 44 extending orthogonally from the body portion 40. The suspension slider assembly 14 further includes a forward lateral frame member 46 and a rearward lateral frame member 48 extending between and weldably connected to the first and second longitudinal frame members 34, 36 at opposite ends thereof. The forward lateral frame member 46 and the rearward lateral frame member 48 are each provided with a C-shaped cross-sectional configuration similar to the lateral frame members 38. While the lateral frame members 38, 46, 48 are weldably connected to the first and second longitudinal frame members 34, 36, other connection methods may be utilized, such as mechanical fasteners, adhesives, and the like.

The vehicle suspension arrangement 10 further includes an air tank 52 supported from the lateral frame members 38 via a pair of mounting brackets 54. In the illustrated example, the air tank 52 is cylindrically-shaped and includes a pair of integral support brackets 56 extending from opposite ends of the air tank 52. Each mounting bracket 54 is V-shaped and includes a body portion 58, a pair of angle portions 60 extending from opposite ends of the body portion 58, and a pair of flanges 62 extending from an associated one of the angled portion 60.

In assembly, the body portion 58 of the mounting brackets 54 are connected to a corresponding one of the support brackets 56 of the air tank 52 via a plurality of mechanical fasteners such as bolts 64. A vibration damper 66 may be positioned between the support brackets 56 and the mounting brackets 54 thereby damping vibrational forces transmitted from the suspension slider assembly 14 to the air tank 52 and reducing the vibrational stresses exerted thereon. Corresponding flanges 62 of each of the mounting brackets 54 are connected to the lateral frame members 38 via a plurality of mechanical fasteners such as bolts 68. In the illustrated example, the air tank 52 is supported between the longitudinal frame members 34, 36 and within a space 70 defined between the lateral frame members 38.

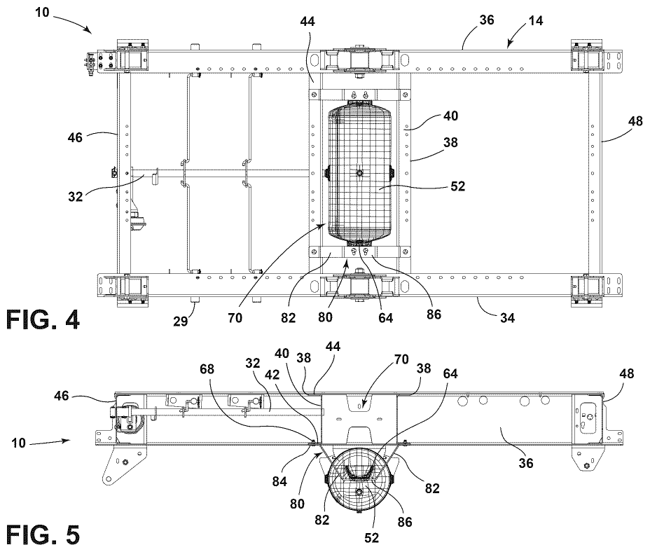

Alternatively, the air tank 52 (FIGS. 4 and 5) may be connected to a single one of the frame members 38 via a pair of Z-shaped brackets 80. In the illustrated example, each bracket includes a body portion 82, a first tab 84 extending angularly from a first end of the body portion 82, and second tab 86 extending angularly from a second end of the body portion 82. In assembly, the first tab 84 of each of the Z-shaped brackets 80 are connected to the bottom flange 44 of one of the frame members 38 via a plurality of mechanical fasteners such as bolts while the second tab 86 is attached to a corresponding mounting bracket 54 of the air tank via a second plurality of mechanical fasteners such as bolts. A vibration damper similar to vibrations damper 66 may also be utilized.

In the foregoing description, it will be readily appreciated by those skilled in the art that modifications may be made to the embodiments described and shown herein without departing from the concepts of those embodiments. Such modifications are to be considered as included in the following claims, unless these claims by their express language expressly state otherwise.

The invention claimed is:

1. A vehicle suspension arrangement, comprising:
a suspension slider assembly, comprising:
a first longitudinal frame member configured to be slidably coupled to a first vehicle frame member;
a second longitudinal frame member laterally spaced from the first longitudinal frame member and configured to be slidably coupled to a second vehicle frame member; and
a pair of lateral frame members extending between and connected to the first and second longitudinal frame members such that the first longitudinal frame member, the second longitudinal frame member and the first and second lateral frame members cooperate to define an open space therebetween;
at least one mounting bracket connected to both of the lateral frame members of the pair of lateral frame members;
an air tank connected to the pair of lateral frame members via the at least one mounting bracket such that the air tank is at least partially in vertical registry with the open space between the first and second lateral frame members;
an axle member configured to support a pair of wheel assemblies; and
a suspension assembly configured to support the suspension slider assembly from the axle member.

2. The vehicle suspension assembly of claim 1, wherein the suspension slider assembly further comprises a forward lateral frame member and a rearward lateral frame member each extending between and connected to the first longitudinal frame member and the second longitudinal frame member, wherein the forward lateral frame member is located forwardly of the pair of lateral frame members and the rearward lateral frame member is located rearwardly of the pair of lateral frame members.

3. The vehicle frame suspension assembly of claim 1, wherein the axle member is one of a pair of axle members including a first axle member located forward of the pair of lateral frame members and second axle member located rearward of the pair of lateral frame members.

4. The vehicle frame suspension assembly of claim 1, further comprising:
a vibration damper positioned between the air tank and the pair of lateral frame members.

5. The vehicle frame suspension assembly of claim 1, further comprising:
a vibration damper positioned between the at least one mounting bracket and the pair of lateral frame members.

6. The vehicle frame suspension assembly of claim 1, wherein the at least one mounting bracket includes a pair of mounting brackets located at opposite ends of the air tank from one another.

7. The vehicle frame suspension assembly of claim 1, wherein the at least one mounting bracket includes a mounting bracket having a V-shape.

8. The vehicle frame suspension assembly of claim 1, wherein the air tank is centrally located along a length of the first longitudinal frame member and along a length of the second longitudinal frame member.

9. The vehicle frame suspension assembly of claim 1, wherein each of the pair of lateral frame members has a vertical portion and a bottom flange extending horizontally from the vertical portion, and wherein the at least one bracket is connected to the bottom flange of each of the pair of lateral frame members.

10. The vehicle frame suspension assembly of claim 1, wherein the suspension assembly includes a spring suspension assembly.

11. The vehicle frame suspension assembly of claim 1, wherein the air tank includes at least one support bracket welded thereto, wherein the at least one support bracket is connected to the at least one mounting bracket.

12. The vehicle frame suspension assembly of claim 1, wherein the air tank is at least partially positioned vertically below a lowermost edge of at least one of the lateral frame members.

13. A vehicle suspension arrangement, comprising:
a suspension slider assembly, comprising:
a first longitudinal frame member configured to be slidably coupled to a first vehicle frame member;
a second longitudinal frame member laterally spaced from the first longitudinal frame member and configured to be slidably coupled to a second vehicle frame member; and
a pair of lateral frame members extending between and connected to the first and second longitudinal frame members such that the first longitudinal frame member, the second longitudinal frame member and the first and second lateral frame members cooperate to define an open space therebetween;
an air tank operably coupled to the pair of lateral frame members such that the air tank is at least partially positioned in vertical registry with the open space between the first and second lateral frame members;
an axle member configured to support a pair of wheel assemblies; and
a suspension assembly configured to support the suspension slider assembly from the axle member.

14. The vehicle suspension arrangement of claim 13, wherein the air tank is connected to the pair of lateral frame members by a pair of mounting brackets extending between and connected to the pair of lateral frame members where the pair of mounting brackets are located at opposite ends of the air tank.

15. The vehicle suspension assembly of claim 13, wherein the suspension slider assembly further comprises a forward lateral frame member and a rearward lateral frame member each extending between and connected to the first longitudinal frame member and the second longitudinal frame member, wherein the forward lateral frame member is located forwardly of the pair of lateral frame members and the rearward lateral frame member is located rearwardly of the pair of lateral frame members.

16. The vehicle frame suspension assembly of claim 13, wherein the axle member is one of a pair of axle members including a first axle member located forward of the pair of lateral frame members and second axle member located rearward of the pair of lateral frame members.

17. The vehicle frame suspension assembly of claim 13, further comprising:
a vibration damper arrangement positioned between the air tank and the pair of lateral frame members and/or between the at least one mounting bracket and the pair of lateral frame members.

18. The vehicle frame suspension assembly of claim 13, wherein the at least one mounting bracket includes a mounting bracket having a V-shape.

19. The vehicle frame suspension assembly of claim 13, wherein the air tank is centrally located along a length of the first longitudinal frame member and along a length of the second longitudinal frame member.

20. The vehicle frame suspension assembly of claim 13, wherein the suspension assembly includes a spring suspension assembly.

21. The vehicle suspension arrangement of claim 13, wherein the air tank is coupled to the frame suspension slider assembly via at least one mounting bracket that extends longitudinally along the suspension slider assembly.

22. A vehicle suspension arrangement, comprising:
a suspension slider assembly, comprising:
a first longitudinal frame member configured to be slidably coupled to a first vehicle frame member;
a second longitudinal frame member laterally spaced from the first longitudinal frame member and configured to be slidably coupled to a second vehicle frame member; and
a pair of lateral frame members extending between and connected to the first and second longitudinal frame members such that the first longitudinal frame member, the second longitudinal frame member and the first and second lateral frame members cooperate to define an open space therebetween;
at least one mounting bracket extending longitudinally along the suspension slider assembly;
an air tank connected to suspension slider assembly via the at least one mounting bracket such that the air tank is in vertical registry with the open space between the first and second lateral frame members;
an axle member configured to support a pair of wheel assemblies; and
a suspension assembly configured to support the suspension slider assembly from the axle member.
